(19) United States
(12) Patent Application Publication
(10) Pub. No.: US 2024/0386369 A1
(43) Pub. Date: Nov. 21, 2024

(54) CUSTOMER-SUPPLIED DRONE RECHARGE FACILITY

(71) Applicant: International Business Machines Corporation, Armonk, NY (US)

(72) Inventors: Logan Bailey, Atlanta, GA (US); Zachary A. Silverstein, Georgetown, TX (US); Jeremy R. Fox, Georgetown, TX (US); Kenneth C. Accetta, Cornelius, NC (US)

(73) Assignee: International Business Machines Corporation, Armonk, NY (US)

(21) Appl. No.: 18/199,847

(22) Filed: May 19, 2023

(51) Int. Cl. G06Q 10/0835; B64U 50/37; G06Q 10/0832

(52) U.S. Cl. CPC G06Q 10/08355; B64U 50/37; G06Q 10/0832; B64U 2101/64

(57) ABSTRACT

A method for extending the range of a delivery drone is disclosed. In one embodiment, such a method includes enabling a customer of a supply chain provider to selectively include a drone charging station of the customer in a drone charging network of the supply chain provider. The method gathers parameters associated with the drone charging station and updates a drone charging map of the supply chain provider to include the drone charging station and its associated parameters. The method further generates, on behalf of the supply chain provider, a delivery plan that utilizes the drone charging station included in the drone charging network. The customer is compensated, by the supply chain provider, for utilization of the drone charging station in executing the delivery plan. A corresponding system and computer program product are also disclosed.

### BACKGROUND

### Field of the Invention

This invention relates to delivery drones, and more particularly to systems and methods for extending the range of delivery drones.

### Background of the Invention

The use of drones for deliveries has been gaining popularity in recent years for obvious reasons. Delivery drones offer a range of benefits, including increased efficiency, reduced costs, and faster delivery times. As technology continues to advance and regulations catch up with the rapid pace of innovation, the importance of delivery drones is only set to grow in the future.

One of the most significant benefits of delivery drones is their ability to make deliveries more efficient. Currently, most deliveries are made by human drivers, who typically have to navigate through traffic and deal with various obstacles such as construction, accidents, and road closures. By contrast, delivery drones can fly directly to their destination without being hampered by traffic or obstacles, making them much faster and more efficient than traditional delivery methods.

Although future use of delivery drones is promising, delivery drones currently have limitations, particularly as it relates to range. These limitations can impact the ability of delivery drones to deliver goods effectively and efficiently. For example, one of the most significant current limitations of delivery drones is battery life. Most delivery drones are powered by batteries, and the flight time of these batteries can be limiting, depending on the weight of the payload and the distance that the drone needs to travel. As a result, the range of many delivery drones is typically limited to a few kilometers or miles.

### SUMMARY

The invention has been developed in response to the present state of the art and, in particular, in response to the problems and needs in the art that have not yet been fully solved by currently available systems and methods. Accordingly, systems and methods have been developed for extending the range of delivery drones. The features and advantages of the invention will become more fully apparent from the following description and appended claims, or may be learned by practice of the invention as set forth hereinafter.

Consistent with the foregoing, a method for extending the range of a delivery drone is disclosed. In one embodiment, such a method includes enabling a customer of a supply chain provider to selectively include a drone charging station of the customer in a drone charging network of the supply chain provider. The method gathers parameters associated with the drone charging station and updates a drone charging map of the supply chain provider to include the drone charging station and its associated parameters. The method further generates, on behalf of the supply chain provider, a delivery plan that utilizes the drone charging station included in the drone charging network. The customer is compensated, by the supply chain provider, for utilization of the drone charging station in executing the delivery plan.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one embodiment of a map of a drone charging network of a supply chain provider, and further showing a delivery area facilitated by the drone charging network;

FIG. 3 is a high-level block diagram showing one embodiment of a map of a drone charging network when various customer-supplied drone charging stations are included in the network;

FIG. 4 is a high-level block diagram showing one embodiment of a map of a drone charging network with different charging rates for customer-supplied drone charging stations;

FIG. 5 is a high-level block diagram showing one embodiment of a map of a drone charging network with different levels of availability for customer-supplied drone charging stations;

FIG. 6 is a process flow diagram showing one embodiment of a method for extending a range of a delivery drone using a drone charging network that utilizes customer-supplied drone charging stations; and

FIG. 7 is a high-level block diagram showing a range extension module in accordance with the invention as well as various sub-modules that may be included in the range extension module.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 for extending the range of a delivery drone (i.e., collectively referred to herein as a “range extension module 150”). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

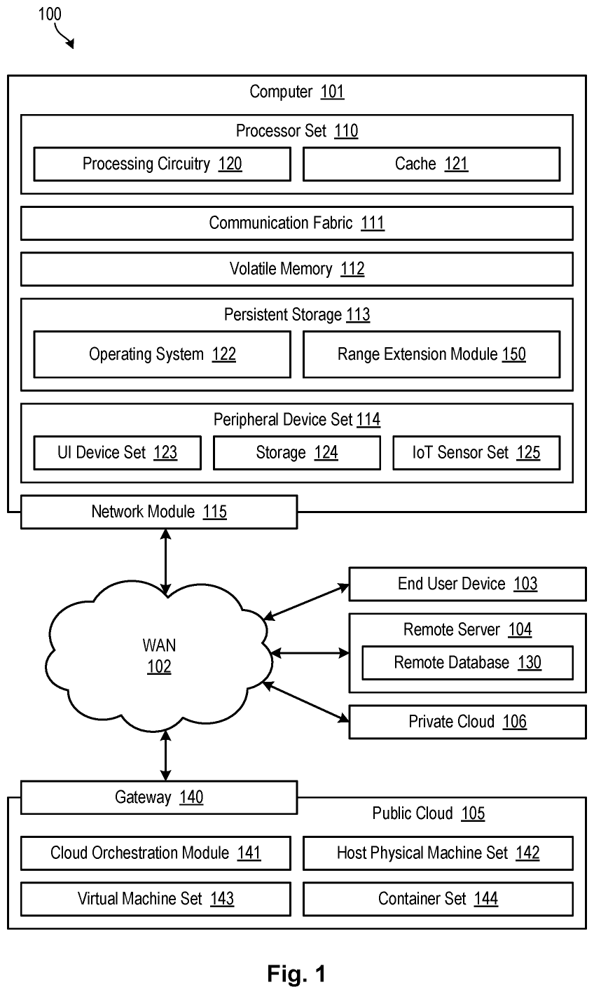

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

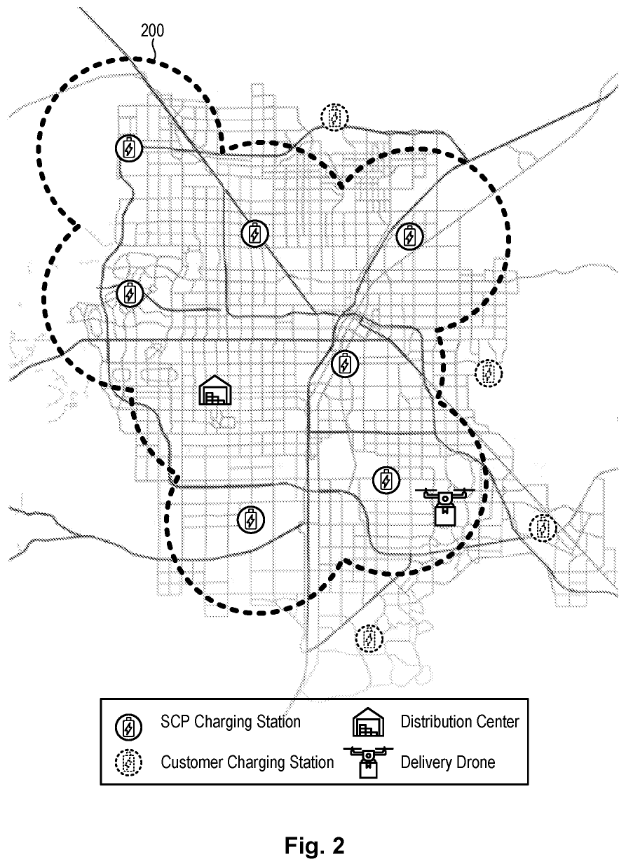

Referring to FIG. 2, as previously mentioned, as delivery drones become more prevalent, there will be an increasing need for charging networks to support their operations. Ideally, these charging stations will be strategically located in areas where delivery drones are likely to operate in order to increase their range. This can make drones more useful for deliveries to remote areas or areas with limited road access. Nevertheless, establishing a charging infrastructure can be expensive and locations for charging stations may be difficult to acquire and maintain. Furthermore, as delivery drones become more prevalent, the infrastructure can be quickly and easily overwhelmed by the demand for its services. Thus, establishing reliable, accessible, and scalable charging infrastructure will be increasingly important.

In certain embodiments, supply chain providers may establish drone charging networks in order to recharge delivery drones utilized by the supply chain providers. In certain embodiments, the drone charging networks are owned and/or maintained by the supply chain providers. As shown in FIG. 2, a drone charging network may, in certain embodiments, include a distribution center and one or more drone charging stations that are associated with the supply chain provider and that are strategically located some distance from the distribution center. Delivery drones may, in certain embodiments, charge at the distribution center prior to leaving on a delivery. Ideally, the range of the delivery drones exceeds the distance between the drone charging stations to enable the delivery drones to hop from one drone charging station to another when delivering items. With the drone charging stations shown in FIG. 2, a drone charging network may in certain embodiments enable a delivery area 200 assuming the delivery drones have enough battery power with a designated payload to travel from a drone charging station to an edge of the delivery area 200 and return to the drone charging station for recharging.

Nevertheless, despite a supply chain provider's best efforts at creating and/or maintaining a drone charging network and placing drone charging stations at optimal locations within the drone charging network, dead spots may exist where a delivery drone is unable to deliver items because the dead spots are too far from a drone charging station to enable return of the delivery drone after delivering an item. In other cases, a drone charging station may exist but the drone charging station may be unavailable for charging if it is already being used. In yet other cases, drone charging stations may go down (i.e., become unavailable) or new areas may be developed that are out of range of drone charging stations in a drone charging network. Thus, it would be advantageous to provide systems and methods to expand a drone charging network, eliminate or reduce dead zones, provide greater robustness and availability of drone charging stations, facilitate access to new developments, and the like.

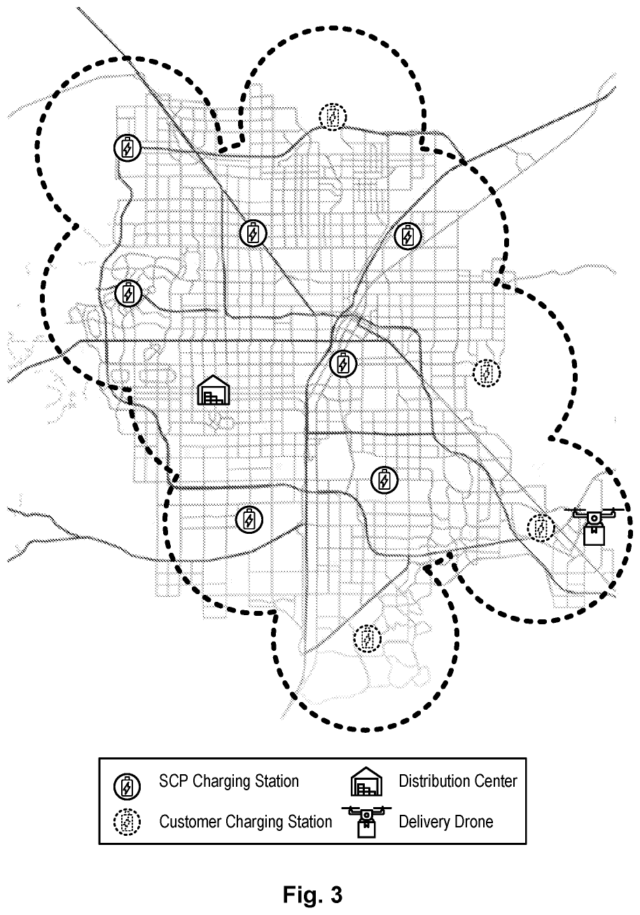

As can be appreciated by those of skill in the art, a supply chain provider that utilizes a drone charging network may have a large base of customers in the area of the drone charging network. In some cases, these customers have the facilities and/or infrastructure to implement a drone charging station. In certain cases, systems and methods in accordance with the invention may enable a customer to selectively opt a drone charging station of the customer into the supply chain provider's drone charging network, with the supply chain provider providing some agreed-upon benefit to the customer in exchange for the supply chain provider's use of the customer's drone charging station. This may enable the supply chain provider to expand the drone charging network and potentially extend the delivery area 200, assuming that various customer-provided drone charging stations are at or near the edge of the delivery area 200. At the very least, the customer-provided drone charging stations may increase the robustness of the drone charging network by adding drone charging stations and thereby increasing charging options and availability to delivery drones utilizing the drone charging network. FIG. 3 is a high-level block diagram showing one embodiment of a map of a drone charging network that includes various customer-supplied drone charging stations in addition to supply chain provider (SCP) drone charging stations within the network.

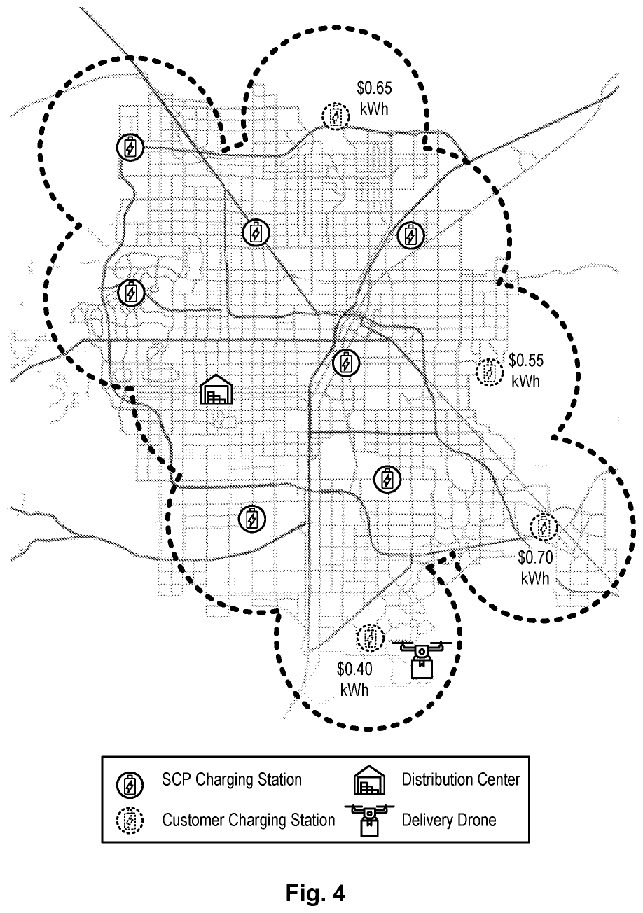

Referring to FIG. 4, as mentioned above, in certain embodiments, a supply chain provider may provide some agreed-upon benefit to a customer in exchange for using the customer's drone charging station. For example, in certain embodiments, the supply chain provider may pay for the power that is being utilized at the customer-provided drone charging stations. For example, the supply chain provider may pay a customer a particular dollar amount per kilowatt hour (kWh) for utilizing the customer's drone charging station. This price may be different or the same for each customer-provided drone charging station. The price may be static over time or the price may change dynamically over time in response to fluctuations in demand for the drone charging station and/or the cost of electricity. In certain cases, multiple vendors or supply chain providers may bid to utilize a customer-provided drone charging station. FIG. 4 is a high-level block diagram showing one embodiment of a map of a drone charging network with different charging rates being used for different customer-supplied drone charging stations.

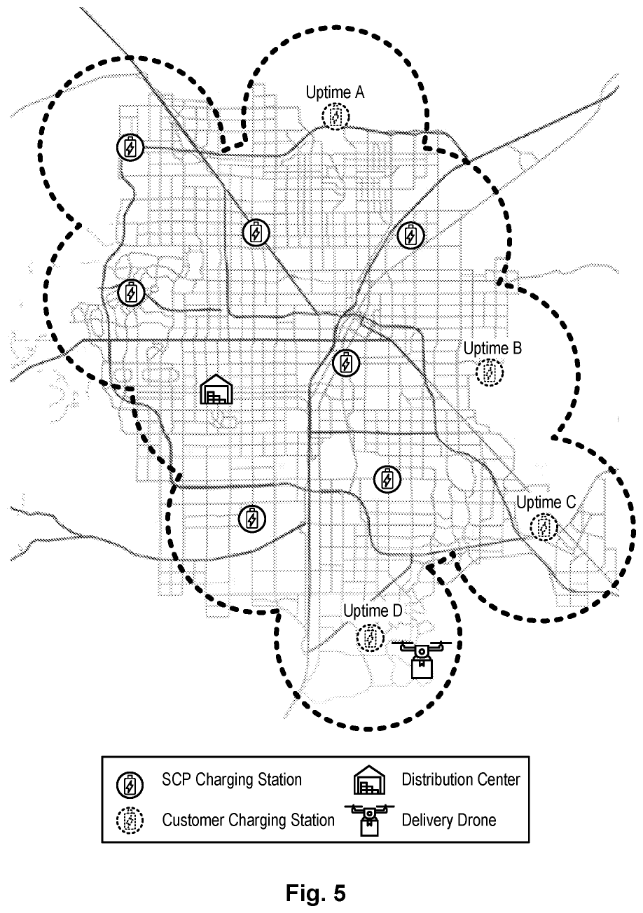

Referring to FIG. 5, in other embodiments, customers may be compensated based on the availability (e.g., uptime) of their drone charging stations, regardless of whether the drone charging stations are actually used. In certain embodiments, this availability may be verified and/or tracked based on “proof of coverage” determined by a periodic signal captured from the drone charging stations. FIG. 5 is a high-level block diagram showing one embodiment of a map of a drone charging network with different levels of availability for customer-supplied drone charging stations.

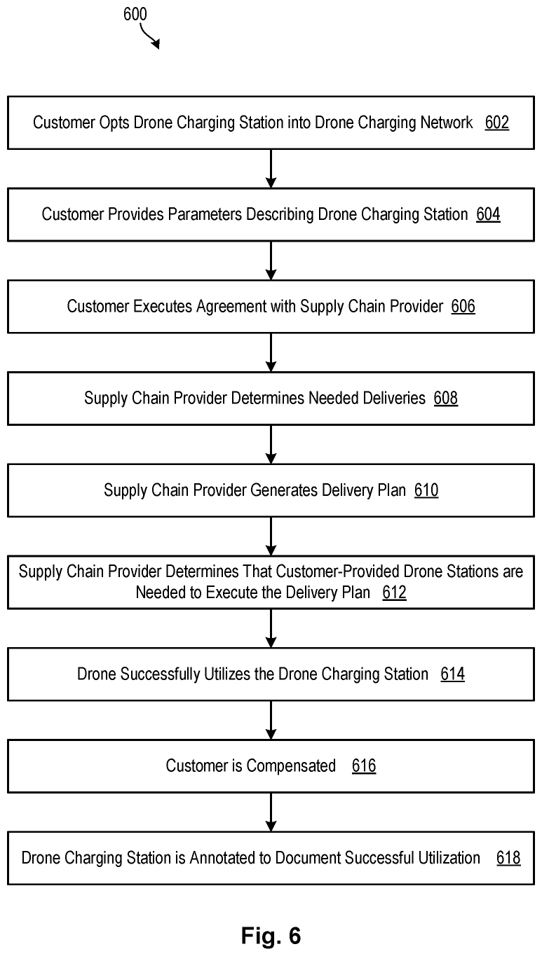

Referring to FIG. 6, a process flow diagram showing one embodiment of a method 600 for extending a range of a delivery drone is illustrated. As shown, a customer may initially opt 602 a drone charging station into a drone charging network of a supply chain provider. In doing so, the customer may provide 604 parameters associated with the drone charging station such as the power output, charging port type, charging speed, hours of availability, charging cost, and/or the like. In certain embodiments, these parameters are discoverable by some signal broadcast from the drone charging station, or discoverable by virtue of the drone charging station's connection to or integration into the drone charging network. In certain embodiments, the customer may execute 606 a parameterized agreement with the supply chain provider that establishes the services/availability/cost of the drone charging station provided by the customer as well as the compensation provided to the customer by the supply chain provider.

With the drone charging network in place, the supply chain provider may determine 608 deliveries that are needed and generate 610 a delivery plan to execute the deliveries. In certain embodiments, this may include determining a most cost- and operationally effective path through the drone charging network and associated drone charging stations to deliver a particular item. In certain embodiments, this may include determining 612 the customer-provided drone charging stations that are needed to execute the delivery plan. In certain embodiments, the customer-provided drone charging stations are only utilized as a last resort since they may be more expensive to use than the drone charging stations of the supply chain provider.

Once the supply chain provider successfully utilizes 614 a customer-provided drone charging station, the supply chain provider may compensate 616 the customer in the agreed-upon manner. The way in which this compensation may occur may vary in different embodiments. For example, in certain embodiments, the supply chain provider may compensate the customer using at least one of money, credits, benefits, products, reduced fees, discounts, delivery prioritization, and/or the like. In certain embodiments, after the customer-provided drone charging station has been successfully utilized by the supply chain provider, a database entry or profile associated with the drone charging station may be annotated 618 to record the successful utilization. In certain embodiments, a blockchain distributed network may be used to track data within the drone charging network.

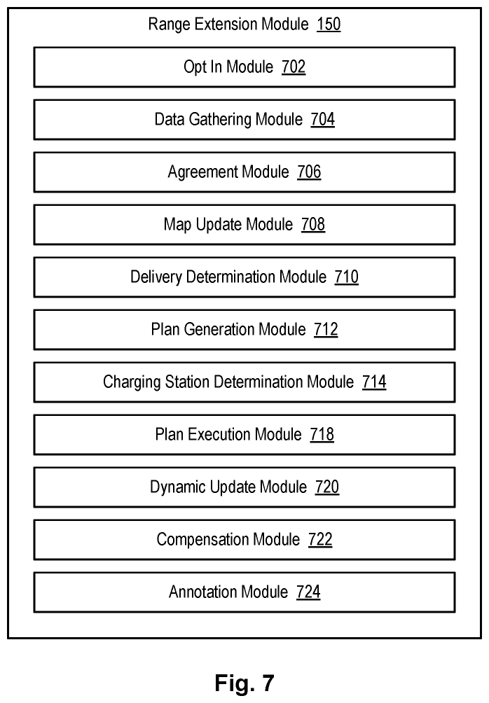

FIG. 7 is a high-level block diagram showing a range extension module 150 and various sub-modules that may be used to extend the range of a delivery drone. The range extension module 150 and associated sub-modules may be implemented in hardware, software, firmware, or combinations thereof. The range extension module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, the range extension module 150 may include one or more of an opt in module 702, data gathering module 704, agreement module 706, map update module 708, delivery determination module 710, plan generation module 712, charging station determination module 714, plan execution module 718, dynamic update module 720, compensation module 722, and annotation module 724.

The opt in module 702 may enable a customer of a supply chain provider to opt a drone charging station of the customer into a drone charging network of the supply chain provider. Upon opting in the drone charging station, the data gathering module 704 may gather data associated with the drone charging station. This data may include, for example, a customer identifier, location of the drone charging station, a power output of the drone charging station, charging port type, charging speed, hours of availability, charging cost, number of charging bays in the drone charging station, and/or the like. In certain embodiments, this data may be stored in a database associated with the drone charging network. In certain embodiments, an agreement module 706 may enable the customer and supply chain provider to execute an agreement that sets forth what is provided by the customer and the compensation to be paid to the customer by the supply chain provider.

Once a customer-provided drone charging station is opted into the drone charging network, the map update module 708 may update a map of the drone charging network to include the customer-provided drone charging station, such as is shown in FIG. 3. In certain embodiments, these customer-provided drone charging stations are marked as active or inactive on the map depending on their availability. The delivery determination module 710 may enable the supply chain provider to determine what deliveries are needed to service the supply chain provider's customers. Using the map generated by the map update module 708, the plan generation module 712 may generate a delivery plan that takes the drone charging network into account. The charging station determination module 714 may determine which drone charging stations, including customer-provided drone charging stations, are needed to execute the delivery plan.

Once a delivery plan is determined, the plan execution module 718 may execute the delivery plan. This may include dispatching delivery drones to perform deliveries in accordance with the delivery plan, which may designate routes to be taken through the drone charging network in delivering items and any stops that are needed to recharge at drone charging stations, including customer-provided drone charging stations if needed. In certain embodiments, the delivery plan sets forth the lowest-cost paths for delivering the items. This delivery plan may be static or dynamic. In cases where the delivery plan is dynamic, the dynamic update module 720 may dynamically update the delivery plan to reflect changes in demand for the drone charging stations, changes in charging cost for the drone charging stations, changes in availability of the drone charging stations, and/or the like. In some cases these changes may occur while a delivery is in process and the dynamic update module 720 may be used to dynamically update the delivery plan accordingly.

When deliveries are complete, the compensation module 722 may compensate customers for use of customer-provided drone charging stations. The annotation module 724 may annotate the successful utilization of the customer-provided drone charging stations in a database.

It should be recognized that the drone charging stations disclosed herein may be configured to provide more than simply charging services. For example, in certain embodiments, the drone charging stations (and even the delivery drones themselves) may be configured to collect and share various types of data, such as temperature, wind, chemical data, light, sound, and even the presence of magnetic objects within a local area. This information may be shared with other drone charging stations and/or delivery drones and be used when developing a delivery plan, dynamically updating a delivery plan, and/or executing a delivery plan.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

What is claimed is:

1. A method for extending a range of a delivery drone, the method comprising:
enabling a customer of a supply chain provider to selectively include a drone charging station of the customer in a drone charging network of the supply chain provider;
gathering parameters associated with the drone charging station;
updating a drone charging map of the supply chain provider to include the drone charging station and its associated parameters;
generating a delivery plan that utilizes the drone charging station included in the drone charging network;
dispatching a delivery drone to perform a delivery in accordance with the delivery plan; and
dynamically updating the delivery plan, while the delivery drone is performing the delivery, based on data collected by, and shared between, respective delivery drones while travelling within a local area, wherein the dynamically updated delivery plan provides a most operationally effective path for the delivery drone to perform the delivery of a particular item.

2. The method of claim 1, wherein gathering parameters comprises gathering at least one of the following parameters associated with the drone charging station: location, customer identity, power output, charging port type, charging speed, hours of availability, and charging cost.

3. The method of claim 1, wherein generating the delivery plan comprises dynamically updating the delivery plan to utilize the drone charging station.

4. The method of claim 1, wherein compensating the customer comprises compensating the customer using at least one of money, credits, benefits, products, reduced fees, discounts, and delivery prioritization.

5. The method of claim 1, wherein at least one of the parameters dynamically changes based on demand for the drone charging station.

6. The method of claim 1, wherein generating the delivery plan comprises utilizing the drone charging station in the event utilizing the drone charging station optimizes the delivery plan.

7. The method of claim 1, further comprising compensating, by the supply chain provider, the customer for utilization of the drone charging station in executing the delivery plan.

8. A computer program product for extending a range of a delivery drone, the computer program product comprising a computer-readable storage medium having computer-usable program code embodied therein, the computer-usable program code configured to perform the following when executed by at least one processor:
enable a customer of a supply chain provider to selectively include a drone charging station of the customer in a drone charging network of the supply chain provider;
gather parameters associated with the drone charging station;
update a drone charging map of the supply chain provider to include the drone charging station and its associated parameters;
generate a delivery plan that utilizes the drone charging station included in the drone charging network;
dispatch a delivery drone to perform a delivery in accordance with the delivery plan; and
dynamically update the delivery plan, while the delivery drone is performing the delivery, based on data collected by, and shared between, respective delivery drones while travelling within a local area, wherein the dynamically updated delivery plan provides a most operationally effective path for the delivery drone to perform the delivery of a particular item.

9. The computer program product of claim 8, wherein gathering parameters comprises gathering at least one of the following parameters associated with the drone charging station: location, customer identity, power output, charging port type, charging speed, hours of availability, and charging cost.

10. The computer program product of claim 8, wherein generating the delivery plan comprises dynamically updating the delivery plan to utilize the drone charging station.

11. The computer program product of claim 8, wherein compensating the customer comprises compensating the customer using at least one of money, credits, benefits, products, reduced fees, discounts, and delivery prioritization.

12. The computer program product of claim 8, wherein at least one of the parameters dynamically changes based on demand for the drone charging station.

13. The computer program product of claim 8, wherein generating the delivery plan comprises utilizing the drone charging station in the event utilizing the drone charging station optimizes the delivery plan.

14. The computer program product of claim 8, wherein the computer-usable program code is further configured to compensate the customer for utilization of the drone charging station in executing the delivery plan.

15. A system for extending a range of a delivery drone, the system comprising:
at least one processor;
at least one memory device operably coupled to the at least one processor and storing instructions for execution on the at least one processor, the instructions causing the at least one processor to:
enable a customer of a supply chain provider to selectively include a drone charging station of the customer in a drone charging network of the supply chain provider;
gather parameters associated with the drone charging station;
update a drone charging map of the supply chain provider to include the drone charging station and its associated parameters;
generate a delivery plan that utilizes the drone charging station included in the drone charging network;
dispatch a delivery drone to perform a delivery in accordance with the delivery plan; and
dynamically update the delivery plan, while the delivery drone is performing the delivery, based on data collected by, and shared between, respective delivery drones while travelling within a local area, wherein the dynamically updated delivery plan provides a most operationally effective path for the delivery drone to perform the delivery of a particular item.

16. The system of claim 15, wherein gathering parameters comprises gathering at least one of the following parameters associated with the drone charging station: location, customer identity, power output, charging port type, charging speed, hours of availability, and charging cost.

17. The system of claim 15, wherein generating the delivery plan comprises dynamically updating the delivery plan to utilize the drone charging station.

18. The system of claim 15, wherein compensating the customer comprises compensating the customer using at least one of money, credits, benefits, products, reduced fees, discounts, and delivery prioritization.

19. The system of claim 15, wherein at least one of the parameters dynamically changes based on demand for the drone charging station.

20. The system of claim 15, wherein generating the delivery plan comprises utilizing the drone charging station in the event utilizing the drone charging station optimizes the delivery plan.
